(19) United States
(12) Patent Application Publication
(10) Pub. No.: US 2003/0037284 A1
(43) Pub. Date: Feb. 20, 2003

(54) Self-monitoring mechanism in fault-tolerant distributed dynamic network systems

(76) Inventors: Anand Srinivasan, Kanata (CA); Pramod Dhakal, Nepean (CA)

Correspondence Address: PILLSBURY WINTHROP, LLP, P.O. BOX 10500, MCLEAN, VA, 22102, US

(21) Appl. No.: 09/963,687

(22) Filed: Sep. 27, 2001

Related U.S. Application Data
(60) Provisional application No. 60/312,060, filed on Aug. 15, 2001.

(51) Int. Cl. H04L 1/22

(52) U.S. Cl. 714/11

(57) ABSTRACT

A fault-tolerant server group operating in client-server distributed dynamic network system environment includes a master server and at least one back-up server. The master server registers its mastership in a name server. The master server communicates with the client and the back-up servers. Each server in the fault-tolerant server group has a self-monitoring mechanism, ensuring a consistent mastership. The fault-tolerant server group processes the request from the client to generate a processing result. The processing result is sent from the master server to the client.

### APPLICATION DATA

This application relates to and claims priority from U.S. patent application Ser. No. 60/312,060, titled “Self-Monitoring Mechanism in Fault-Tolerant Distributed Dynamic Network Systems,” filed Aug. 15, 2001, the contents of which are incorporated herein by reference.

This patent application and another are being filed simultaneously that relate to various aspects of fault tolerant distributed dynamic network systems. The other patent application is entitled “Electing A Master Server Using Election Periodic Timer in Fault-Tolerant Distributed Dynamic Network Systems”, and is also invented by Anand Srinivasan and Pramod Dhakal and is commonly assigned herewith. The subject matter of “Electing A Master Server Using Election Periodic Timer in Fault-Tolerant Distributed Dynamic Network Systems” is hereby incorporated herein by reference.

### BACKGROUND

1. Field of the Invention

Aspects of the present invention relate to the field of network systems. Other aspects of the present invention relate to fault-tolerant server groups in distributed dynamic network systems.

2. General Background and Related Art

Client and server architecture is nowadays adopted in most computer application systems. With this architecture, a client sends a request to a server and the server processes the client request and sends results back to the client. Typically, multiple clients may be connected to a single server. For example, an electronic commerce system or an eBusiness system may generally comprise a server connected to a plurality of clients. In such an eBusiness system, a client conducts business electronically by requesting the server to perform various business-related computations such as recording a particular transaction or generating a billing statement.

More and more client and server architecture based application systems cross networks. For example, an eBusiness server located in California in the U.S.A. may be linked to clients across the globe via the Internet. Such systems may be vulnerable to network failures. Any problem occurring at any location along the pathways between a server and clients may compromise the quality of service provided by the server.

A typical solution to achieve a fault tolerant server system is to distribute replicas of a server across, for example, geographical regions. To facilitate the communication between clients and a fault tolerant server system, one of the distributed servers may be elected as a master server. Other distributed servers in this case are used as back-up servers. The master server and the back-up servers together form a virtual server or a server group.

FIG. 1 shows a typical configuration of a client and a server group across a network. In FIG. 1, a server group comprises a master server 110 and a plurality of back-up servers 120a, . . . ,120b, 120c, . . . 120d. The master server 110 communicates with its back-up servers 120a, 120b, 120c, and 120d via network 140. The network 140, which is representative of a wide range of communication networks in general such as the Internet, is depicted here as a “cloud”. A client 150 in FIG. 1 communicates with server group via the master server 110 through the network 140, sending requests to and receiving replies from the master server 110.

A global name server 130 in FIG. 1 is where the master server 110 registers its mastership and where the reference to a server group, such as the one shown in FIG. 1, can be acquired or retrieved. The global name server 130 may also be distributed according to, for example, geographical locations (not shown in FIG. 1). In this case, the distributed name servers may coordinate among themselves to maintain the integrity and the consistency of the registration of master servers.

In FIG. 1, even though the client 150 interfaces only with the master server 110, all the back-up servers maintain the same state as the master server 110. That is, the client requests are forwarded to all back-up servers 120a, 120b, 120c, and 120d so that the back-up servers can concurrently process the client requests. The states of the back-up servers are synchronized with the state of the master server 110.

In a fault tolerant server system, when the master server fails, back-up servers elect a new master. The newly elected master then establishes itself as the master and resumes connections to the clients and the other back-up servers. While this scheme provides a fall-back for a master server, it may cause inconsistency problems when the failure of the system is actually a failure of the network rather than the original master. FIG. 2 illustrates the problem.

In FIG. 2, network failure caused by, for example, network congestion or other malfunction may cause communications between the master server 110 and some back-up servers to be interrupted. For example, in FIG. 2, if a link between the master server 110 and the shaded area 210 is congested or otherwise blocked, the back-up servers in the shaded area 210 may temporarily lose connection with the master server 110. In this case, the server group in FIG. 2 may be partitioned into two parts: one comprising the master server 110a and the back-up servers 120a, . . . ,120b and the other is the shaded area 210, representing the area that is affected by the network problem.

The network partitioning of a sufficient duration (e.g., specified by a time-out criterion) may cause the back-up servers in the partitioned area 210 to believe that the master server 110a has failed and to elect a new master 110b. The newly elected master server 110b may subsequently assume the responsibility of a master server. Therefore, a temporary isolation of the master server 110a may lead to an inconsistent situation in which multiple master servers exist. When the network is restored, multiple members of the server group claim to be the master and they may not even be aware of the existence of the other masters.

### SUMMARY OF THE INVENTION

This invention provides a way for a fault-tolerant server group to automatically resolve an inconsistent mastership situation in which an undesirable number of master servers exist. In one aspect, an inconsistent situation is detected where more than a desired number of master servers exist. When such a situation is detected, the group re-corrects to create a consistent situation in which only desired number of mater servers exist.

### BRIEF DESCRIPTION OF THE DRAWINGS

The present invention is further described in the detailed description which follows, by reference to the noted drawings by way of non-limiting exemplary embodiments, in which like reference numerals represent similar parts throughout the several views of the drawings, and wherein:

FIG. 1 shows a typical configuration of a client and a virtual server across network;

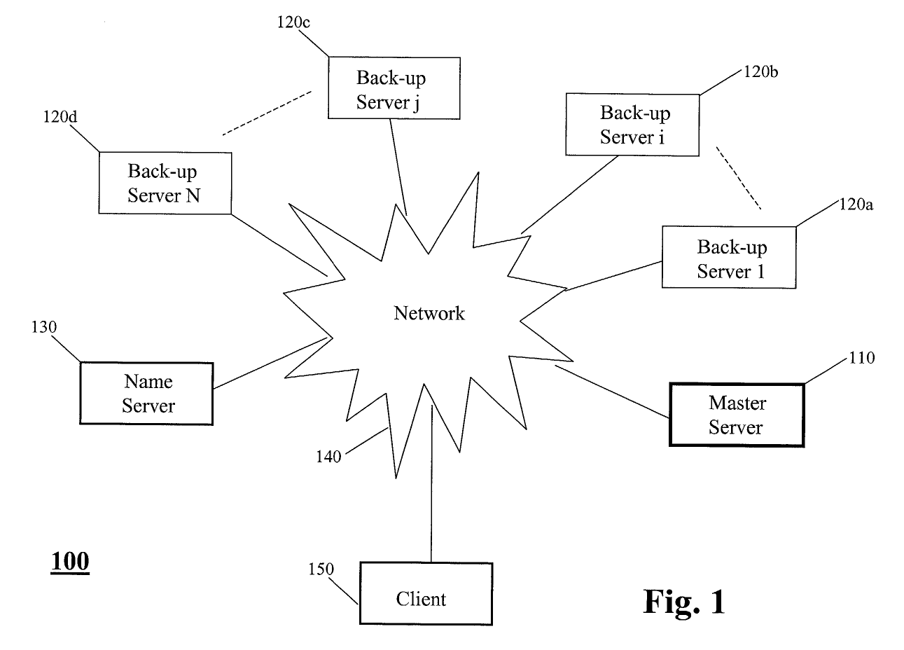

FIG. 2 illustrates the problem of inconsistent mastership;

FIG. 3 shows an embodiment of the invention, in which a self-monitoring mechanism is active on both master server and back-up servers;

FIG. 4 describes a high level functional block diagram of a preferred embodiment of a self-monitoring mechanism;

FIG. 5 shows a high level functional block diagram of a detection mechanism, in which detection is triggered by different mechanisms;

FIG. 6 shows a sample external event triggering mechanism;

FIG. 7 is a high level functional block diagram of a detector that detects an inconsistent mastership situation;

FIG. 8 shows a sample flowchart for detecting an inconsistent mastership situation;

FIG. 9 is a high level functional block diagram of a recovery mechanism which restores a consistent mastership situation;

FIG. 10 shows a sample flowchart for recovering from an inconsistent mastership situation;

FIG. 11 shows a partial functional configuration of a name server; and

FIG. 12 shows a sample flowchart of a name server that corrects multiple registrations of master servers for a server group and that triggers a self-monitoring mechanism.

### DETAILED DESCRIPTION OF SEVERAL EMBODIMENTS

The invention is described below, with reference to detailed illustrative embodiments. It will be apparent that the invention can be embodied in a wide variety of forms, some of which may be quite different from those of the disclosed embodiments. Consequently, the specific structural and functional details disclosed herein are merely representative and do not limit the scope of the invention.

The processing described below may be performed by a general-purpose computer alone or in connection with a specialized computer. Such processing may be performed by a single platform or by a distributed processing platform. In addition, such processing and functionality can be implemented in the form of special purpose hardware or in the form of software being run by a general-purpose computer. The term “mechanism” herein, is intended to refer to any such implementation. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

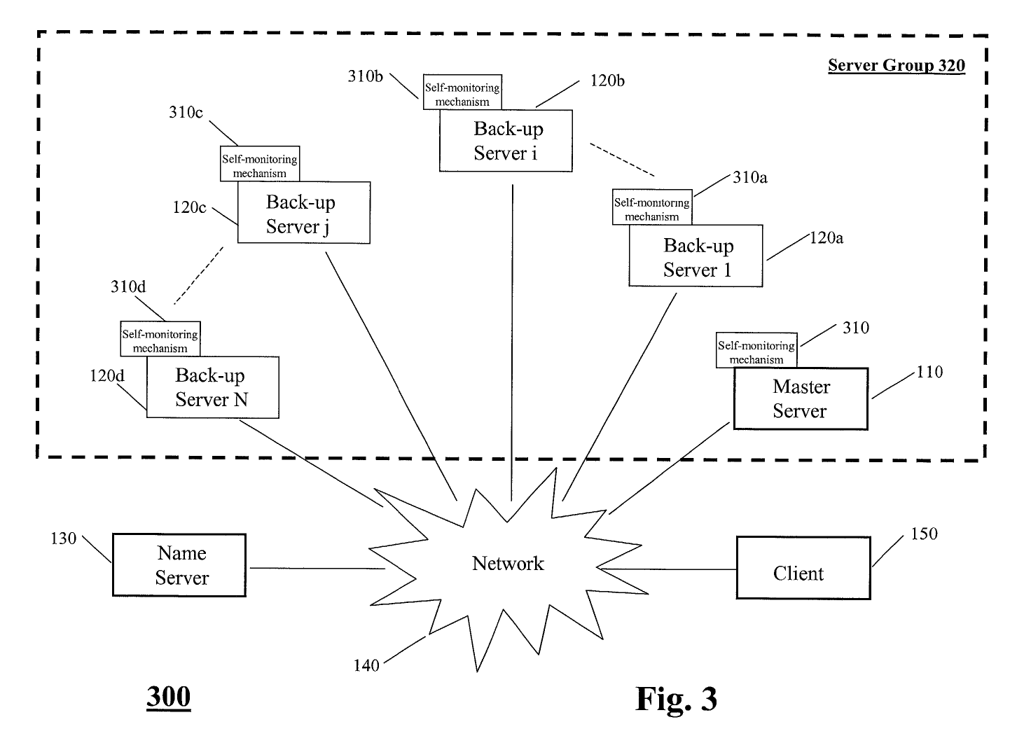

FIG. 3 shows an embodiment 300 of the invention, in which a self-monitoring mechanism is active on all the servers, including a master server and a plurality of back-up servers, that form a server group. System 300 comprises a server group 320 which includes a master server 110, a plurality of back-up servers 1-N 120a, . . . ,120b,120c, . . . ,120d, and a plurality of self-monitoring mechanisms 310a, . . ,310b,310c, . . . ,310d (attached to the master server 110 as well as to the back-up servers 1-N 120a, . . . , 120b,120c, . . . , 120d), a name server 130, a client 150, and a network 140. Although the server group 320 in FIG. 3 includes one desired master server, it should be appreciated that a server group may include more than one desired master servers.

The master server 110 and the back-up servers 1-N 120a, . . . , 120b,120c, . . . , 120d in FIG. 3 form the fault tolerant server group 320 that provides the client 150 services. Example of such services may include Internet Service Provider services or on-line shopping services. The servers in the server group 320 may be distributed across the globe. For example, the master server 110 may be physically located in Ottawa, Canada, the back-up server 1 120a may be physically located in Atlanta, Ga., USA, the backup server i 120b may be physically located in Bangalore, the back-up server j 120c may be physically located in Sydney, and the back-up server N 120d may be physically located in Tokyo. The servers in the server group 320 communicate with each other via the network 140 which is representative of a wide range of communications networks in general.

The mastership of the master server 110 may be registered in the name server 130. The name server 130 may also be distributed (not shown in FIG. 3). The integrity and consistency of the registrations for the masters across all server groups are maintained among distributed name servers. The registration may involve the explicit use of the name of a server group under which a master server, elected for the server group, may be registered using a server ID.

The client 150 communicates with the server group 320 by interfacing with the master server 110. The master server 110 interacts with the back-up servers via the network 140. When the client 150 sends a request to the master server 110, the master server 110 forwards the client's request to the back-up servers 1-N (120a, . . . , 120b,120c, . . . , 120d). All the servers in the server group 320 concurrently process the client's request and the master server 110 sends the results back to the client 150. The states of the servers in the server group 320, including the master server 110 and the back-up servers 1-N 120a, . . . , 120b,120c, . . . , 120d, are synchronized.

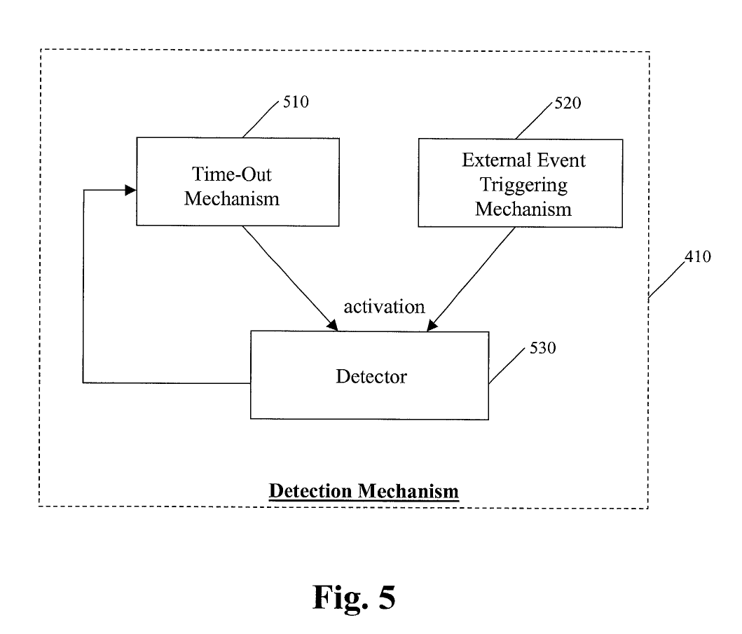

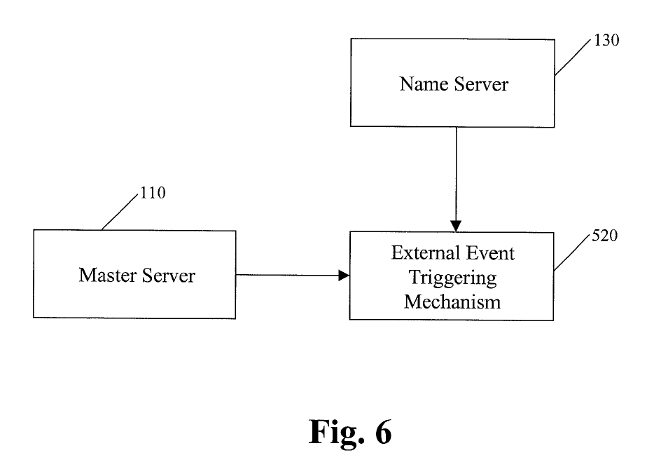

The self-monitoring mechanisms 310a, . . . , 310b,310c, . . . , 310d are attached to the servers in the server group 320 to detect inconsistent mastership situations and, once such inconsistency is detected, to restore a consistent mastership within the server group 320. The self-monitoring mechanisms 310a, . . . , 310b,310c, . . . ,310d are in action whenever they are simultaneously activated or triggered. The condition under which the self-monitoring mechanisms are triggered will be discussed below with reference to FIG. 5 and FIG. 6.

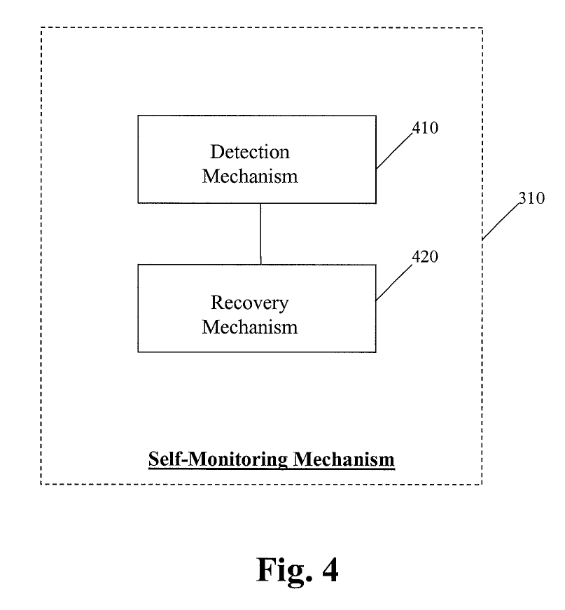

FIG. 4 shows a high level functional diagram of a self-monitoring mechanism 310. In FIG. 4, the self-monitoring mechanism 310 comprises a detection mechanism 410 and a recovery mechanism 420. When the self-monitoring mechanism 310 is triggered, its detection mechanism 410 first identifies a situation in which inconsistent mastership exists, particularly, the situation in which multiple servers in the server group 320 claim to be the master server. Upon detecting the inconsistent mastership in the server group 320, the recovery mechanism 420 restores a consistent mastership within the server group 320.

FIG. 5 is a high level functional block diagram of the detection mechanism 410. In FIG. 5, the detection of an inconsistent situation is activated by two sample mechanisms. One is a time-out mechanism 510 that activates a detector 530 based on a pre-determined time-out criterion. The time-out criterion may specify a particular length in time after which the detector 530 in the self-monitoring mechanism 310 is automatically activated. The length of time may be counted according to different time unit determined by, for example, a timer. Such a timer may be set up to measure time in units of a second, multiple seconds, a millisecond, or multiple milliseconds, for example. For instance, a time-out criterion may be specified as 100 counts in time according to a timer with a unit of 3 milliseconds. In this case, the time-out criterion is satisfied every 300 milliseconds. That is, every 300 milliseconds, the time-out mechanism 510 automatically activates the detector 530 to check whether there is any inconsistent mastership.

A different sample activation mechanism shown in FIG. 5 is the external event triggering mechanism 520. It is a triggering mechanism that reacts to some pre-defined events that are external to the self-monitoring mechanism 310. Examples of such external events may include the name server 130 detecting a conflict in master server registration or a master server detecting that there is one or more other servers from a same server group that also claim to be the master. When such a pre-determined external event occurs, the external event triggering mechanism 520 is notified and consequently generates an activation signal to activate the detector 530.

The two activation mechanisms illustrated in FIG. 5 may play complementary roles. The time-out mechanism 510 may be designed to regulate the frequency of self-monitoring. For example, the frequency may be set up as every 10 seconds. The frequency may be adjusted based on different criteria such as the geographical distance among different servers in a server group.

The external event triggering mechanism 520 may be designed for activating the detector 530 on demand, which may be based on some dynamic event. The external event triggering mechanism 520 may override the time-out mechanism 510. For example, between the two activating points regulated by the time-out mechanism 510, if a relevant external event occurred that signals an inconsistent mastership situation, the external event triggering mechanism 520 may step in and activate the detector 530, despite the fact that it has not reached the next activating time yet according to the time-out mechanism 510.

FIG. 6 illustrates how the external event triggering mechanism 520 may be notified of the occurrence of relevant external events. As an example, the external event triggering mechanism 520 may be connected to both the name server 130 and the master server 110. When the name server 130 detects that there are multiple registrations under the same server group name (with different server IDs), the name server 130 notifies the external event triggering mechanism 520. In this case, the external event triggering mechanism 520 activates the detector 530.

When the name server 130 detects an inconsistent mastership situation by identifying multiple registrations of masters under the same server group's name, the name server 130 may decide to retain only one master in the registration based on some criterion and to remove others. For example, the name server 130 may decide to retain the master server that has the lowest ID.

After the name server 130 retains only one master in the registration, the inconsistent mastership situation may still persist unless that the retained master server is acknowledged by all the servers in the server group 320 and that the servers that have registered as master servers but have been removed from the name server 130 correct their states accordingly. To do so, the name server 130 may notify the external event triggering mechanism 520 so that the detectors 530 in the self-monitoring mechanisms 310a, . . . , 310b,310c, . . . , 310d of the servers in the server group 320 are activated.

In a different embodiment, if the master server 110 detects that there are other servers from the server group 320 that also claim to be the master, the master server 110 notifies the external event triggering mechanism 520 to activate the detector 530 so that the inconsistent mastership may be resolved.

Both mechanisms 510 and 520 may be provided, or just one of them or some other triggering mechanism.

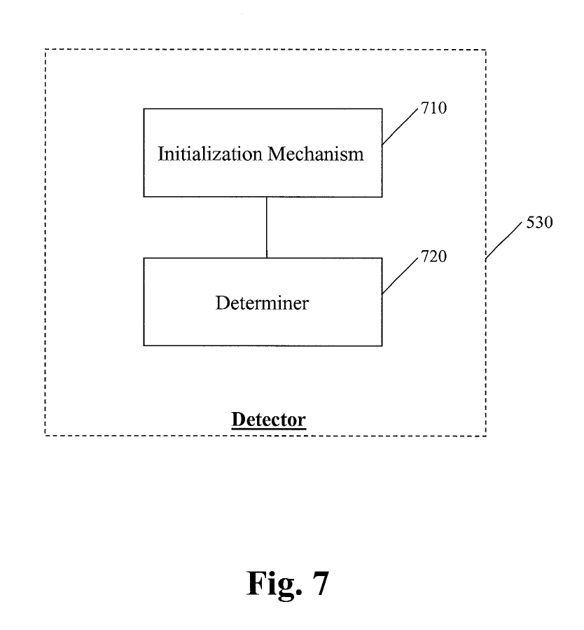

When a detector 530 is activated, it examines whether its underlying server (the server to which the detector 530 is attached to) is involved in an inconsistent mastership situation. FIG. 7 shows a sample functional block diagram of the detector 530, which comprises an initialization mechanism 710 and a determiner 720. When the detector 530 is activated, the initialization mechanism 710 first sets the initial state of various variables that are used in the self-monitoring mechanism 310.

The determiner 720 determines whether the underlying server is involved in an inconsistent mastership situation. For example, if the state of the underlying server indicates that it is a master server but is not the retained master server registered in the name server 130, the underlying server is creating an inconsistent mastership situation. A different example is when the master of the underlying server, indicated by the master state of the underlying server, is not the retained master server registered in the name server 130. In both cases, the underlying server is involved in an inconsistent situation and needs correction.

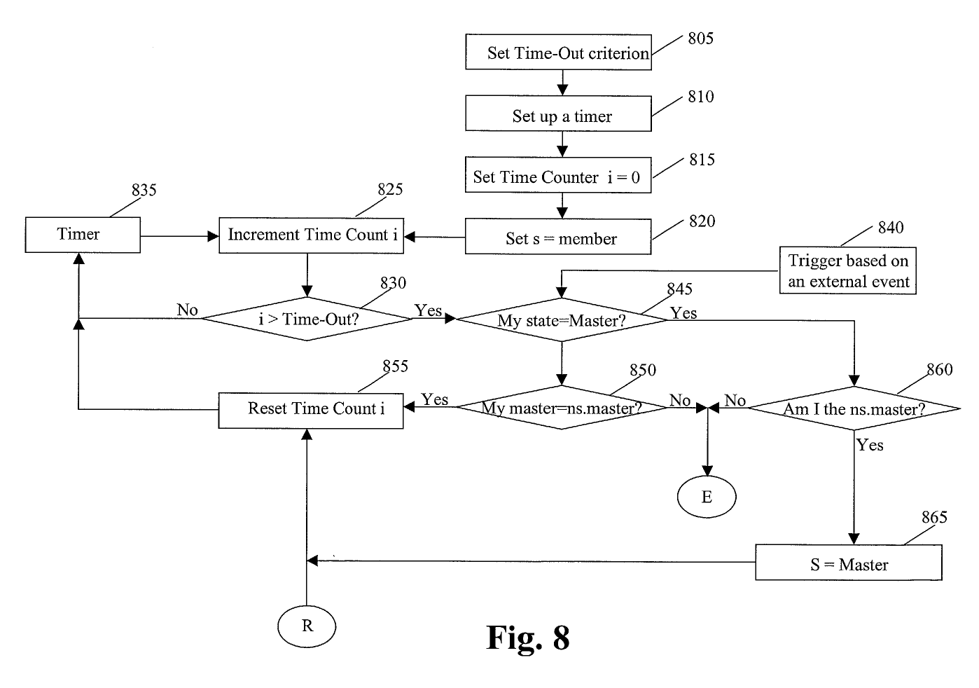

FIG. 8 is a sample flowchart of the detection mechanism 410. As described earlier, the self-monitoring mechanism 310 may be invoked by different activation mechanisms. In FIG. 5, two sample activating mechanisms are depicted. One is the time-out based activation mechanism 510 and the other is the external event based activation mechanism 520. The flowchart illustrated in FIG. 8 incorporates both activation mechanisms.

In FIG. 8, various variables used in the detection mechanism 410 are initialized at acts 805 to 820. For example, variables related to the time-out mechanism 510 are specified at acts 805 to 815: a time-out criterion is initialized at act 805, according to, for example, a particular timer, which is further initialized at act 810. The time counter i to be used to count towards the time-out criterion is initialized at act 815. The time-out mechanisms across all the self-monitoring mechanisms 310a, . . . , 310b,310c, . . . , 310d in the server group 320 may be synchronized. At act 820, an underlying server is initialized as a member that participates in a self-monitoring process.

When there is no external event triggering the detection mechanism 410, the time-out mechanism regulates how frequently an underlying server performs self-monitoring. The time counter i is incremented at act 825. Whether the time-out criterion is satisfied is examined at act 830. If the time-out criterion is not satisfied, the process proceeds to a timer at act 835. The timer will hold until certain amount of time, specified at act 810, has elapsed before allowing the time counter to be incremented again at act 825. If the time-out criterion is satisfied at act 830, the self-monitoring is activated. In this case, the process proceeds to act 845 to examine whether the underlying server is attributing to an inconsistent mastership situation.

When there is an external event that triggers the detection mechanism 410, the external event triggering mechanism 520 activates the detection of an inconsistent mastership situation. The triggering from an external event may take effect even when the time-out criterion is not satisfied (i.e., the external event triggering mechanism 520 overrides the time-out mechanism 510). This is achieved at act 840. Once the detection is activated, by either the time-out mechanism 510 or by the external event triggering mechanism 520, the detection mechanism 410 examines first, at act 845, the state of the underlying server.

If the state of the underlying server indicates that it is not a master server (i.e., it is a back-up server), the detection mechanism 410 further examines, at act 850, to see whether the master of the underlying back-up server is the master server defined in the name server 130. If the master of the underlying back-up server is indeed the same as the master server defined in the name server 130, the underlying server is not contributing to an inconsistent mastership. In this case, no correction is required. The process proceeds to act 855 where the time counter is reset.

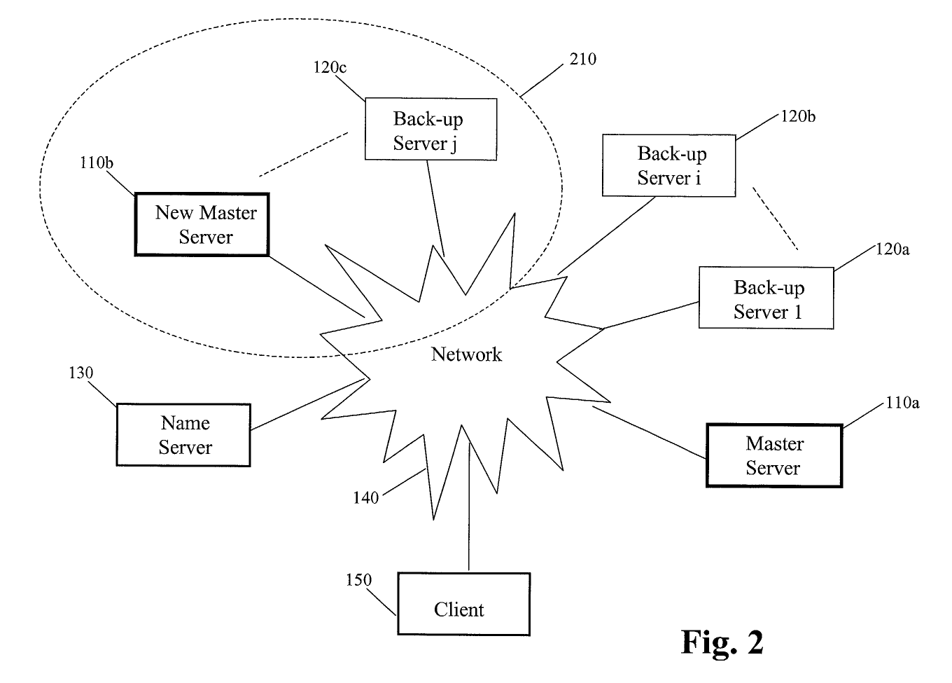

If the master of the underlying back-up server is not the master server defined in the name server 130, it may indicate that the underlying server is under the control of a master server that has been eliminated from the name server. That is, the underlying server is involved in an inconsistent mastership situation. For example, when a network partition 210 occurs (as shown in FIG. 2), the back-up servers within the network partition 210 may elect a new master server 110b. When this happens, the master states of other back-up servers in the network partition 210 will be set to point to the new master server 110b. When the network partition 210 is removed, the name server 130 may restore the sole mastership of the master server 110a. In this case, the master states of the back-up servers in the network partition 210, currently pointing to a server whose mastership has been eliminated, need to be reset. The process will proceed to exception handling E, during which recovery is performed by the recovery mechanism 420.

If the state of the underlying server indicates that it is a master server, determined at act 845, the detection mechanism 410 further examines, at act 860, whether the underlying server is the master server defined in the name server 130. If the underlying server is the master server defined in the name server 130, the underlying server is the sole master server in a consistent mastership situation. In this case, the state of the underlying server is set to be the master at act 865 and there is no need to correct the state of the underlying server. The process simply proceeds to act 855 to reset the time counter i.

If the underlying server is not the master server defined in the name server 130, the underlying server attributes to an inconsistent mastership situation. For example, the new master server 110b (shown in FIG. 2), elected when the network partition 210 exists, will be considered as creating an inconsistent mastership situation once the network partition 210 is removed. In this case, the states of the underlying server may need to be realigned with the sole master server retained in the name server 130. The process proceeds to exception handling E, during which recovery is performed by the recovery mechanism 420.

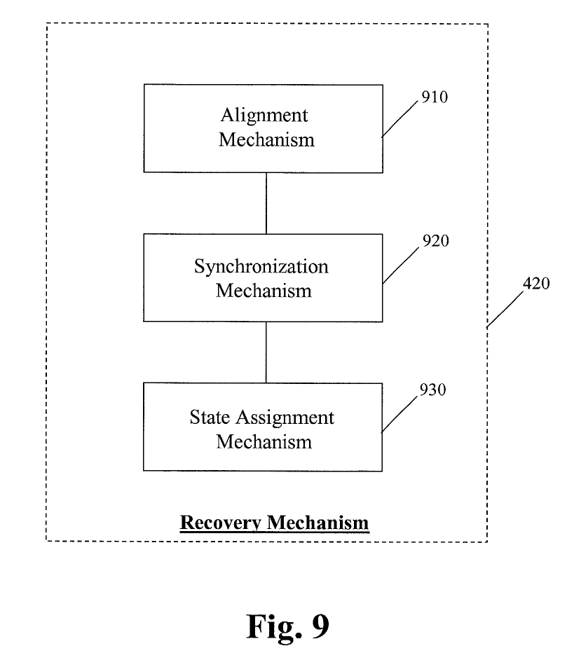

FIG. 9 is a sample functional block diagram of the recovery mechanism 420. The recovery mechanism 420 comprises an alignment mechanism 910, a synchronization mechanism 920, and a state assignment mechanism 930. The alignment mechanism 910 aligns an underlying server in accordance with the sole mastership defined by the name server 130. For example, a back-up server in the server group 320 may have its master state set as the master server defined in the name server 130. The synchronization mechanism 920 makes sure that the states of back-up servers are synchronized with the state of the master server defined in the name server 130. The state assignment mechanism 930 then accordingly assigns the correct state to the underlying server.

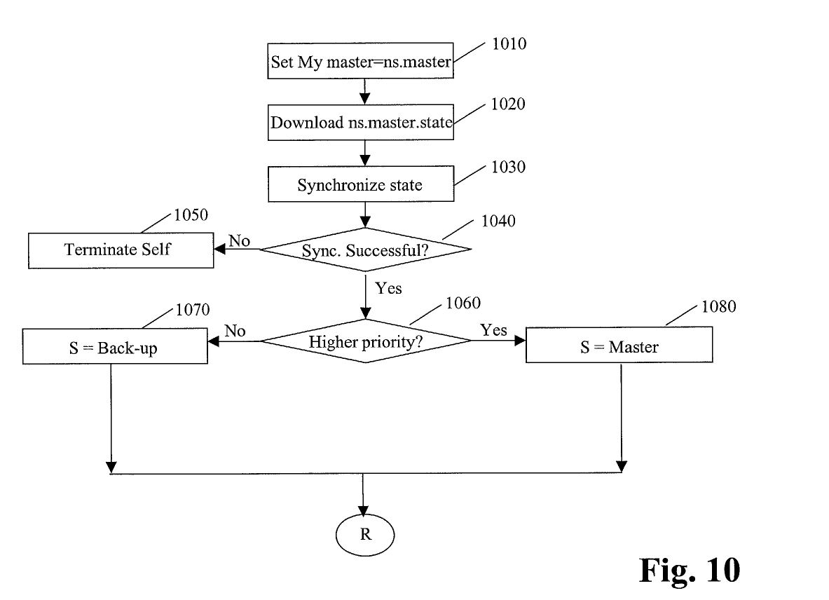

FIG. 10 shows a sample flowchart of the recovery mechanism 420. In the self-monitoring mechanism 310, the processing only enters the stage of recovery if there is an inconsistent mastership situation detected by the detection mechanism 410. The conditions to enter the recovery stage include when a server is set to be a master server but it is not the master server defined in the name server 130 or when a back-up server indicates a current master server which is not the master server defined in the name server 130. In both cases, the underlying server is a back-up server and its master server should be set to be the master server defined in the name server 130. This is achieved at act 1010 of the flowchart shown in FIG. 10. The recovery mechanism 420 then further synchronizes the state of the back-up server with the state of the master server. This is achieved by downloading, at act 1020, the current state of the master, defined in the name server 130, and then by synchronizing, at act 1030, the state of the back-up server with the current state of the master server.

If the synchronization is not successful, determined at act 1040, the recovery mechanism 420 in the self-monitoring mechanism 310 simply terminates, at act 1050, the underlying server. If the synchronization is successful, the state of the underlying server needs to be set accordingly so that the sole mastership can be established. There may be different alternatives. One possible embodiment is to simply assign the state of the underlying server as a back-up server (not shown in FIG. 10).

A different embodiment may provide further opportunity in establishing a sole master server according to some criterion, such as application needs. That is, instead of simply accepting the choice of the retained master made by the name server 130, the servers in the server group 320 may elect, during the recovery, a master server. In some applications, it may be necessary to elect a master server according to an application requirement. Particularly, the criterion used by the name server 130 may not take into account the specific requirements that have to be imposed in electing an appropriate master server. As an example, the name server 130 may choose to retain a master server simply based on the value of the IDs of the servers (e.g., retain the master server registration that corresponds to a lowest ID value, as described earlier). Although a sole mastership may be regained based on such a decision, the choice of the retained master server based on such a decision may not be the one that is the most suitable for the tasks to be performed by the master. For example, the retained master server may not have enough bandwidth to efficiently conduct a real-time video conferencing session between the client 150 and the server group 320. This may be particularly inappropriate when the original master server (before a network partition) is actually chosen according to application needs (such as certain bandwidth) and is later (after the network partition is removed) replaced by a different server, as the new master server, that has inadequate bandwidth for the application, simply because the ID of the new master server has a smaller value then the ID of the original master server.

It may be desirable, therefore, to retain a master server that satisfies certain criterion related to the tasks to be performed. Such a criterion may be specified based on the needs according to the nature of the application. An alternative embodiment is described in FIG. 10 that enables the re-selection of a master, during the recovery stage in which the sole mastership is being restored.

In FIG. 10, after the synchronization is successfully performed, the recovery mechanism 420 determines, at act 1060, whether the underlying server has the highest priority compared with all other servers in the server group 320 (including the current master server retained by the name server 130). If the priority of the underlying server is not the highest, the underlying server is assigned as a back-up server at act 1070. If the underlying server has the highest priority, the recovery mechanism 420 may make the underlying server as the master server by assigning, at act 1080, the state of the underlying server to be the master.

The priority used during the comparison performed at act 1060 may be defined according to application needs. Subsequently, the server ID used to register the mastership of a server at the name server 130 may be determined so as to be consistent with the priority of the server. For example, the value of a server ID may be inversely correlated with the priority of the server. With an appropriate server ID, when the underlying server registers its mastership with the name server 130, it can be successfully retained as the sole master server.

The solution adopted by the name server 130 to resolve a multiple mastership situation (by retaining only one master server) using the criterion of, for example, the lowest ID may serve as a transitional solution. The transitional solution may provide the server group 320 a consistent or stable situation and then the server group 320 may elect a new master server. By doing so, the server group 320 may move from one consistent situation in which the sole master server is the one retained by the name server 130 to a different consistent situation in which a master server is elected from all the servers in the server group 320 according to application needs.

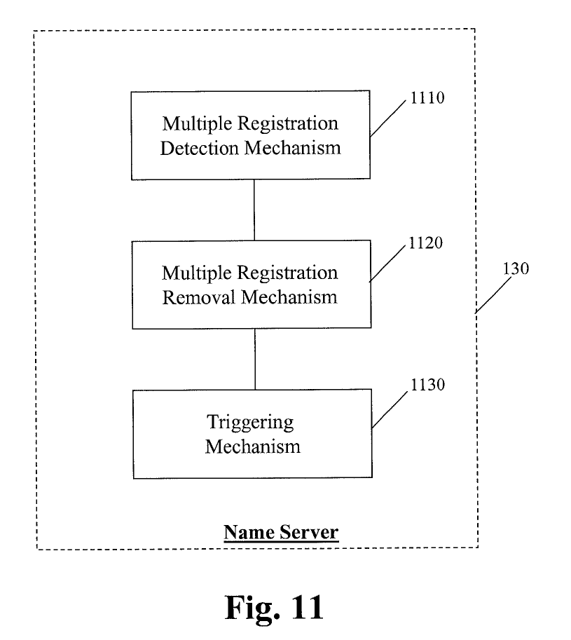

FIG. 11 is a sample high level functional block diagram of the name server 130. A name server may be implemented as an independent server or a distributed group of servers connected to the network 140. It may also be realized as a function on a computer connected to the network 140, either in the form of a hardware mechanism or a software module. In FIG. 11, the name server 130 comprises a multiple registration detection mechanism 1110, a multiple registration removal mechanism 1120, and a triggering mechanism 1130. As described earlier, the server group 320 may be partitioned due to network problems or delayed network responses. During the partition, new masters may be elected from isolated network portions and these masters may all be registered in the name server 130 at the point the network partition is removed.

To restore a sole mastership for the server group 320, the multiple registration detection mechanism 1110 in the name server 130 detects the situation in which there are multiple registered masters from the same server group. The detection may be based on server ID conflict. For example, the name server 130 may record a registration based on a server group name and the corresponding server ID of the master server. If only one master is allowed, each server group corresponds to only one server ID. Therefore, if there are multiple registrations with different server IDs under a same server group name, the name server 130 detects an inconsistent mastership situation.

The multiple registration removal mechanism 1120 corrects the inconsistent situation by retaining only one registration under each server group name. Certain criterion may be applied to determine which registration to retain. For example, a registration with a lowest server ID may be retained. Once the master server to be retained is selected, registrations corresponding to other servers may be removed.

When the function of name server 130 is distributed over multiple servers, the multiple registration detection mechanism 1110 and the multiple registration removal mechanism 1120 may need to be implemented accordingly. For example, the multiple registration unit 1110, in this case, detects an inconsistent mastership situation from the registrations across all the distributed name servers. That is, the multiple registration detection mechanism 1110 may need to coordinate among different name servers and to detect inconsistent mastership by comparing the registrations on different name servers across network. Similarly, the multiple registration removal mechanism 1120 may have to be designed so that the removal of multiple registrations across the distributed name servers can be performed consistently.

As discussed earlier, an inconsistent mastership situation needs to be further corrected in each server involved in the inconsistent situation. This is activated by the triggering mechanism 1130. To restore a consistent mastership, the triggering mechanism 1130 in the name server 130 notifies the external event triggering mechanism 520 across all the servers in the server group 320 simultaneously so that the self-monitoring mechanisms 310a, . . . , 310b,310c, . . . , 310d are concurrently activated to restore a consistent situation.

The multiple registration detection mechanism 1110, the multiple registration removal mechanism 1120, and the triggering mechanism 1130 together facilitate the self-monitoring mechanism 310. The block diagram for the name server 130 illustrated in FIG. 11 may also include other functional blocks (not shown in FIG. 11) to facilitate the conventional functionalities that a name server performs.

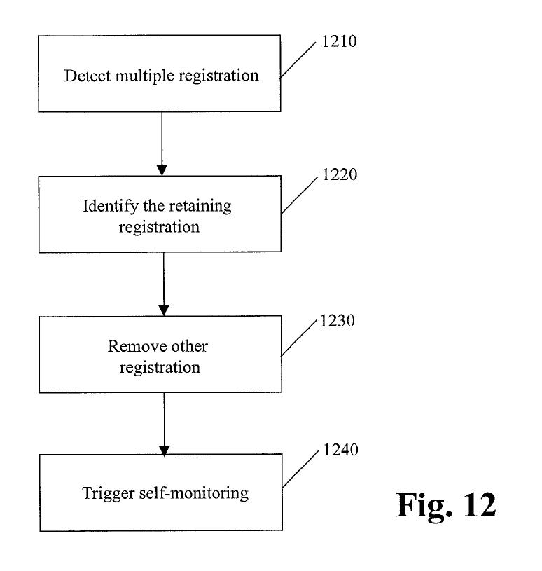

FIG. 12 is a sample flowchart for the name server 130. At act 1210, the multiple registration unit 1110 detects inconsistent mastership registrations in the name server 130. The multiple registration removal mechanism 1120 then identifies, at act 1220, the master server to be retained. Subsequently, the multiple registration removal mechanism 1120 removes, at act 1230, the other registered master registrations from the name server 130 so that only one master registration remains in the name server 130. The triggering mechanism 1130 then triggers the self-monitoring mechanisms 310a, . . . , 310b,310c, . . . 310d in all the servers 110, 120a, . . . , 120b,120c, . . . , 120d within the underlying server group 320 to restore a consistent mastership.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A method for operating a fault-tolerant server group in client-server distributed dynamic network systems, comprising:
receiving, by a master server in a fault-tolerant server group, a request sent by a client, said fault-tolerant server group comprising said master server and at least one back-up server, said master server registering its mastership in a name server and communicating with both said client and said at least one back-up server, every server in said server group, including said master server and said at least one back-up server, having a self-monitoring mechanism, said self-monitoring mechanism ensuring that said fault-tolerant server group has a consistent mastership situation;
processing, by said fault-tolerant server group, said request to produce a result, said request being processed concurrently by said master server and said at least one back-up server; and
sending, by said master server, said result to said client.

2. The method according to claim 1, further comprising
determining, by said self-monitoring mechanism, whether multiple master servers exist within said fault-tolerant server group; and
restoring a consistent mastership situation in which a sole server serves as said master server in said fault-tolerant server group.

3. A method for operating a self-monitoring mechanism in fault-tolerant distributed dynamic network systems, said method comprising:
detecting an inconsistent situation in which more than a desired number of master servers exist; and
recovering, if said inconsitent stuation is detected by said detecting, from said inconsistent situation to create a consitent situation in which the desired number of master server exists.

4. The method according to claim 3, wherein said detecting an inconsistent situation comprises identifying:
a master server that is not a name server master server, wherein said name server master server is a server defined as a master in a name server, said master server that is different from a name server master server causing said inconsisitent situation; or
a master of a back-up server that is not a name server master server, the master of said back-up server causing said inconsistent situation.

5. The method according to claim 4, wherein said identifying a master server comprises:
selecting a server whose state indicates that said server is a master;
determining said server, selected by said selecting, as said master server that causes said inconsistent situation if said server is not a name server master server defined in said name server; and
setting the state of said server as master if said server is the name server master server.

6. The method accoring to claim 4, wherein said identifying a master of a back-up server comprises:
selecting a server whose state indicates that said server is a back-up; and
determining the master of said server, selected by said selecting, as causing said inconsistent situation if the master of said server is not a name server master server defined in said name server.

7. The method according to claim 4, wherein said recoverying from said inconsistent situation comprises:
setting the master of a server, identified by either said identifying a master server or said identifying a master of a back-up server, to be a name server master server;
synchronizing the state of said server with the state of said name server master server;
terminating said server if said synchronizing is not successful; and
setting the state of said server as a back-up, if said synchronizing is successful.

8. The method according to claim 7, wherein said synchronizing comprises:
downloading the state of a name server master server from said name server master server to said server; and
aligning the state of said server with said state of the name server master server, downloaded from said name server master server.

9. The method according to claim 7, further comprising:
comparing, if said synchronizing is successful, the priority of said server with the priority of said name server master server, said priority being defined according to at least one criterion; and
setting the state of said server as a master, if the priority of said state is higher than the priority of said name server master server.

10. The method according to claim 9, wherein
said at least one criterion includes at least one of computing speed and capacity.

11. The method according to claim 4, further comprising:
initializing the state of said server;
initializing a time-out condition;
setting up a timer; and
performing said detecting when said timer achieves said time-out condition.

12. The method according to claim 3, further comprising triggering a server to perform said detecting.

13. The method according to claim 12, wherein
said triggering includes triggering using a time-out mechanism;
said triggering includes triggering by a master server; and
said triggering includes triggering by a name server when said name server detects multiple server IDs that correspond to a same name.

14. The method according to claim 13, wherein said triggering using a time-out mechanism includes triggering using a time-out mechanism based on a timer.

15. The method according to claim 13, wherein said triggering by a master server includes triggering when said master server is an original name server master server and when there is at least one different master server, registered in said name server that are not an original name server master server.

16. The method according to claim 3, further comprising reinitializing a time-out mechanism when no inconsistent situation is detected by said detecting.

17. A method for operating a name server, said method comprising:
detecting multiple registrations of master servers; and
retaining, when multiple registrations of master servers are detected, one master server registration according to a criterion.

18. The method according to claim 17, wherein said multiple registrations of master servers use a same server group's name with different server IDs.

19. The method according to claim 18, wherein said retaining includes keeping a registration of a master server that has the lowest server ID.

20. The method according to claim 17, further comprising:
triggering a self-monitoring mechanism when multiple registrations of master servers are detected.

21. A fault-tolerant server group in distributed dynamic network systems, comprising:
a client;
a fault-tolerant server group for providing a service to said client, said fault-tolerant server group comprising at least one master server and at least one back-up server, said master server communicating with said client, said fault-tolerant server group having a self-monitoring mechanism that ensures that a consistent mastership situation in said fault-tolerant server group; and
a name server for registering the mastership of a master server corresponding to said fault-tolerant server group.

22. The system according to claim 21, wherein said self-monitoring mechanism includes a portion installed on said at least one master server and said at least one back-up server, in said fault-tolerant server group.

23. A self-monitoring mechanism in fault-tolerant distributed dynamic network systems, comprising:
a detection mechanism for detecting an inconsistent situation in which more than a desired number of master servers exist; and
a recovery mechanism for recoverying, if said inconsistent situation is detected by said detection mechanism, from said inconsistent situation to create a consistent situation in which said desired number of master servers exist.

24. The system according to claim 23, wherein said detection mechanism comprises:
a trigger that reacts upon an external event to activate said detection mechanism to perform said detecting;
a time-out mechanism for generating an activation signal, according to a time-out criterion, to start said detecting; and
a detector for performing said detecting, said detector being activated by either said trigger or said time-out mechanism.

25. The system according to claim 24, wherein said external event includes when a name server detects more than the desired number of registrations of master servers.

26. The system according to claim 24, wherein said external event includes when a master server detects the existence of another master server.

27. The system according to claim 24, wherein said time-out mechanism includes a timer and counts towards said time-out criterion based on said timer.

28. The system according to claim 24, wherein said detector comprises:
an initializer for initializing a timer, time-out criterion, and self-monitoring state;
a determiner for determining whether a server is involved in said inconsistent situation.

29. The system according to claim 23, wherein said recovery mechanism comprises:
an alignment mechanism for aligning a server with said master server by assigning one of said master servers as the master of said server;
a synchronization mechanism for synchronizing the state of said server with the state of said one of said master servers; and
a state assignment mechanism for assigning the state of said server.

30. A system of a name server, said system comprising:
a detector for detecting multiple registrations of master servers; and
a correction unit for, when multiple registrations of master servers are detected, retaining only one master server registration.

31. The system according to claim 30, further comprising:
a triggering mechanism for triggering said self-monitoring when multiple registrations of master servers are detected.

32. A computer readable medium having program code stored thereon, such that when the code is read and executed by a computer, the computer is caused to:
receive, by a master server in a fault-tolerant server group, a request sent by a client, said fault-tolerant server group comprising said master server and at least one back-up server, said master server registering its mastership in a name server and communicating with both said client and said at least one back-up server, every server in said server group, including said master server and said at least one back-up server, having a self-monitoring mechanism, said self-monitoring mechanism ensuring that said fault-tolerant server group has a consistent mastership situation;
process, by said fault-tolerant server group, said request to produce a result, said request being processed concurrently by said master server and said at least one backup server; and
send, by said master server, said result to said client.

33. The medium according to claim 32, wherein the code recorded on the medium further causes the computer to:
determine, by said self-monitoring mechanism, whether multiple master servers exist within said fault-tolerant server group; and
restore a consistent mastership situation in which a sole server serves as said master server in said fault-tolerant server group.

34. A computer readable medium having program code stored thereon, such that when the code is read and executed by a computer, the computer is caused to:
detect an inconsistent situation in which more than a desired number of master servers exist; and
recover, if said inconsitent stuation is detected by said detecting, from said inconsistent situation to create a consitent situation in which the desired number of master server exists.

35. The medium according to claim 34, wherein the code recorded on the medium further causes the computer to identify:
a master server that is not a name server master server, wherein said name server master server is a server defined as a master in a name server, said master server that is different from a name server master server causing said inconsisitent situation; or
a master of a back-up server that is not a name server master server, the master of said back-up server causing said inconsistent situation.

36. The medium according to claim 35, wherein the code recorded on the medium further causes the computer to perform said identifying of a master server by:
selecting a server whose state indicates that said server is a master;
determining said server, selected by said selecting, as said master server that causes said inconsistent situation if said server is not a name server master server defined in said name server; and
setting the state of said server as master if said server is the name server master server.

37. The medium according to claim 35, wherein the code recorded on the medium further causes the computer to perform said identifying of a master of a back-up server by:
selecting a server whose state indicates that said server is a back-up; and
determining the master of said server, selected by said selecting, as causing said inconsistent situation if the master of said server is not a name server master server defined in said name server.

38. The medium according to claim 35, wherein the code recorded on the medium further causes the computer to:
set the master of a server, identified by either said identifying a master server or said identifying a master of a back-up server, to be the name server master server;
synchronize the state of said server with the state of said name server master server;
terminate said server if said synchronize is not successful; and
set the state of said server as a back-up, if said synchronize is successful.

39. The medium according to claim 38, wherein the code recorded on the medium further causes the computer to:
download the state of a name server master server from said name server master server to said server; and
align the state of said server with said state of the name server master server, downloaded from said name server master server.

40. The medium according to claim 38, wherein the code recorded on the medium further causes the computer to:
compare, if said synchronize is successful, the priority of said server with the priority of said name server master server, said priority being defined according to at least one criterion; and
set the state of said server as a master, if the priority of said state is higher than the priority of said name server master server.

41. The medium according to claim 35, wherein the code recorded on the medium further causes the computer to:
initialize the state of said server;
initialize a time-out condition;
set up a timer; and
performing said detecting when said timer achieves said time-out condition.

42. The medium according to claim 34, wherein the code recorded on the medium further causes the computer to trigger a server to perform said detect.

43. The medium according to claim 42, wherein
said trigger includes triggering using a time-out mechanism;
said trigger includes triggering by a master server; and
said trigger includes triggering by a name server when said name server detects multiple server IDs that correspond to a same name.

44. The medium according to claim 43, wherein said trigger using a time-out mechanism includes a trigger using a time-out mechanism based on a timer.

45. The medium according to claim 43, wherein said triggering by a master server includes triggering when said master server is an original name server master server and when there is at least one different master server, registered in said name server that is not the original name server master server.

46. The medium according to claim 34, wherein the code recorded on the medium further causes the computer to reinitialize a time-out mechanism when no inconsistent situation is detected by said detect.

47. A computer readable medium having program code stored thereon, such that when the code is read and executed by a computer, the computer is caused to:
detect multiple registrations of master servers; and
retain, when multiple registrations of master servers are detected, one master server registration according to a criterion.

48. The medium according to claim 47, wherein said multiple registrations of master servers use a same server group's name with different server IDs.

49. The medium according to claim 47, wherein said retaining includes keeping a registration of a master server that has the lowest server ID.

50. The medium according to claim 47, wherein the code recorded on the medium further causes the computer to:
trigger a self-monitoring mechanism when multiple registrations of master servers are detected.
